(19) United States
(12) Patent Application Publication
(10) Pub. No.: US 2020/0143347 A1
(43) Pub. Date: May 7, 2020

(54) STOCK KEEPING UNIT (SKU) DRIVEN BUDGETED PURCHASES

(71) Applicant: INTERNATIONAL BUSINESS MACHINES CORPORATION, ARMONK, NY (US)

(72) Inventors: Julia Jankowski, Raleigh, NC (US); Elizabeth C. Huntley, Raleigh, NC (US); Taylor Presley, Raleigh, NC (US); Kaleigh E. Williams, Raleigh, NC (US)

(21) Appl. No.: 16/179,043

(22) Filed: Nov. 2, 2018

(51) Int. Cl. G06Q 20/12; G06Q 30/06; G06Q 30/02; G06Q 20/40

(52) U.S. Cl. CPC G06Q 20/12; G06Q 20/405; G06Q 30/0206; G06Q 30/0635

(57) ABSTRACT

A method, computer system, and a computer program product for managing an electronic payment application is provided. The present invention may include managing online assets using a digital portal, whereby the digital portal determines a purchase order based on conditions of a wish list and a prioritization schedule being met, and releases funds to trigger the electronic purchase of a target item.

### BACKGROUND

The present invention relates generally to the field of computing, and more particularly to e-commerce.

Online shopping may be a convenient mechanism for busy consumers to purchase services and/or products. A consumer's convenience, however, may be limited by the amount of time a consumer may have to browse websites and search for services and/or goods that meet the consumer's intended price point. Consumers may choose to contribute a sum of money to the purchase of a desired service and/or product, but the contributed sum may not be enough to purchase the service and/or product at the service's and/or product's current price point. As a result, the consumer may continuously review the price of desired services and/or products until the price of the service and/or product aligns with the consumer's budget.

### SUMMARY

Embodiments of the present invention disclose a method, computer system, and a computer program product for managing an electronic payment application. The present invention may include managing online assets using a digital portal, whereby the digital portal determines a purchase order based on conditions of a wish list and a prioritization schedule being met, and releases funds to trigger the electronic purchase of a target item.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for budgeted purchases according to at least one embodiment;

FIG. 3 is a block diagram of internal and external components of computers and servers depicted in FIG. 1 according to at least one embodiment;

FIG. 4 is a block diagram of an illustrative cloud computing environment including the computer system depicted in FIG. 1, in accordance with an embodiment of the present disclosure; and

FIG. 5 is a block diagram of functional layers of the illustrative cloud computing environment of FIG. 4, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for budgeted purchases. As such, the present embodiment has the capacity to improve the technical field of e-commerce by enabling a user (i.e., a consumer) to purchase a service and/or product at a desired price point, and to determine the best time to contribute funds to a desired service and/or product without continuously browsing to search for services and/or products which fall within the user's budget. More specifically, the present invention may include managing online assets using a digital portal, whereby the digital portal determines a purchase order based on conditions of a wish list and a prioritization schedule being met, and releases funds to trigger the electronic purchase of a target item.

Online shopping may be a convenient mechanism for busy consumers to purchase services and/or products. A consumer's convenience, however, may be limited by the amount of time a consumer may have to browse websites and to search for services and/or goods that meet the consumer's intended price point. Consumers may choose to contribute a sum of money to the purchase of a desired service and/or product, but the contributed sum may not be enough to purchase the service and/or product at the service's and/or product's current price point. As a result, the consumer may continuously review the price of desired services and/or products until the price of the service and/or product aligns with the consumer's budget. This task may be tedious and time consuming, particularly in instances where a consumer may not have specialized expertise, and may not be aware of the best purchasing source for a desired service and/or product.

Therefore, it may be advantageous to, among other things, provide a mechanism by which a single platform accepts a list of desired services and/or products of a user, maintains a piggybank (e.g., a coin base, a bank account) with funds contributed by the user, and dynamically (e.g., actively) scans purchasing sources (e.g., online merchants) for a best price of a desired service and/or product, ultimately advising the user on when to make a purchase.

According to at least one embodiment, the budget purchase program may permit a user to purchase services and/or products without actively browsing the internet, and may further advise a user as to an optimal time to contribute funds to a desired item.

According to at least one embodiment, the budget purchase program may enable a user to save one or more stock keeping units (SKUs), from one or more online retailers, within a single platform. A user may prioritize saved items based on desirability and affordability, among many other considerations of the user.

According to at least one embodiment, the budget purchase program may allocate funds of the user to the user's desired items based on priority lists established by the user and further based on availability and affordability of the user's desired items.

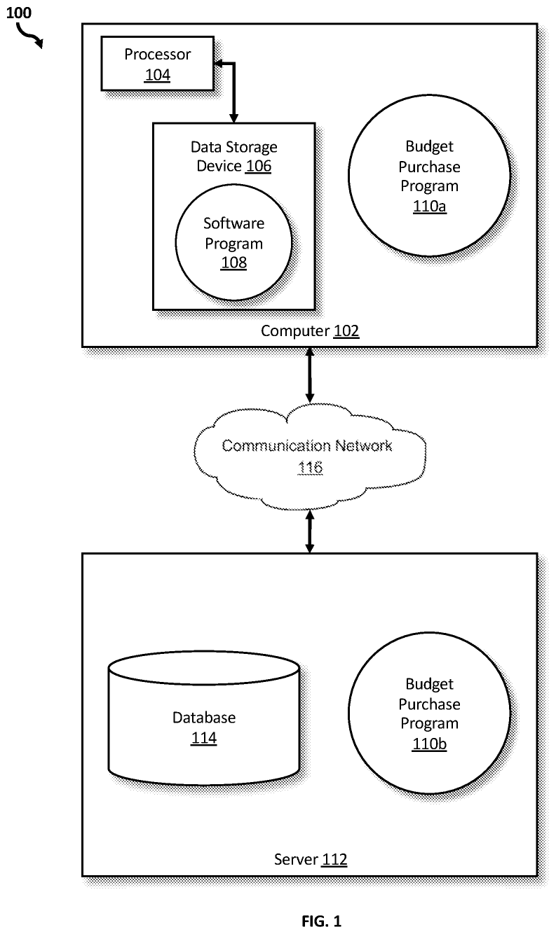

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a budget purchase program 110a. The networked computer environment 100 may also include a server 112 that is enabled to run a budget purchase program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

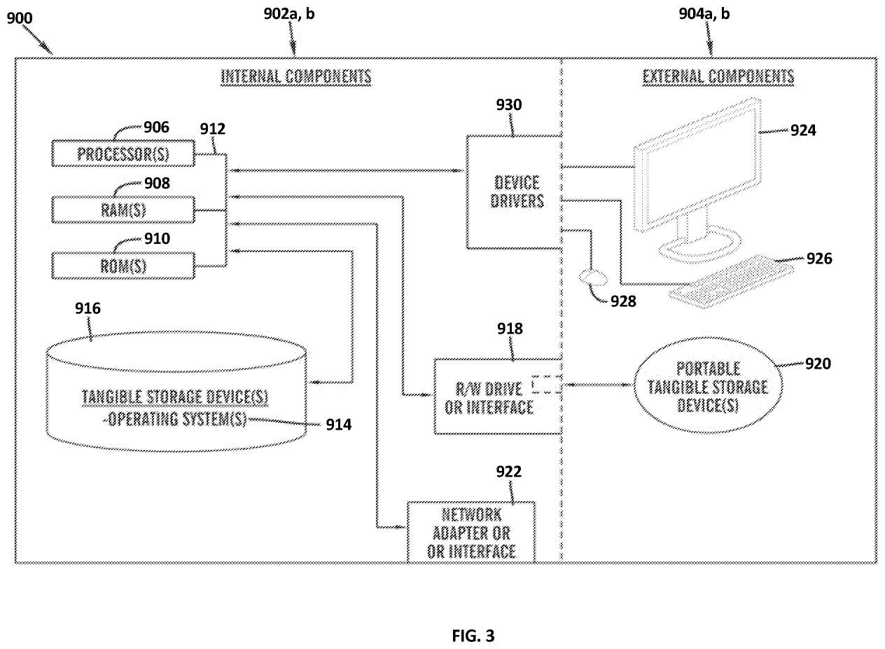

The client computer 102 may communicate with the server computer 112 via the communications network 116. The communications network 116 may include connections, such as wire, wireless communication links, or fiber optic cables. As will be discussed with reference to FIG. 3, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the budget purchase program 110a, 110b may interact with a database 114 that may be embedded in various storage devices, such as, but not limited to a computer/mobile device 102, a networked server 112, or a cloud storage service.

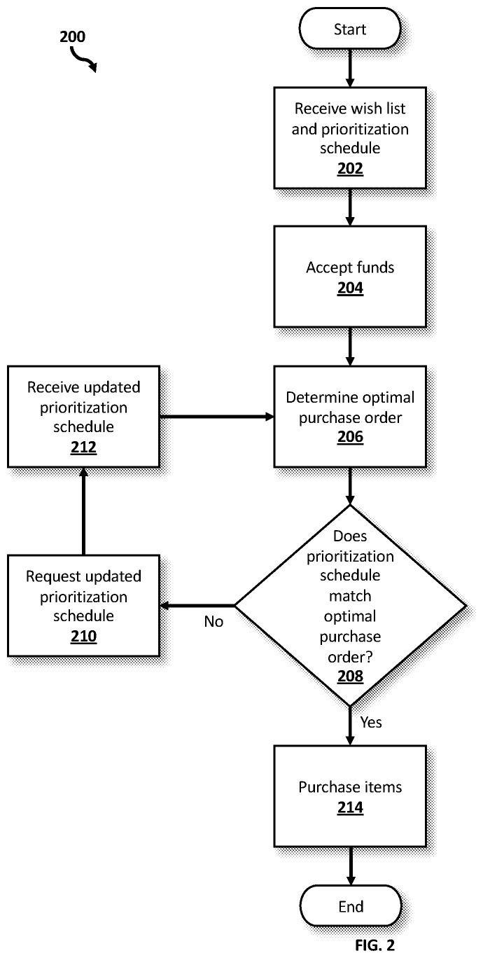

According to the present embodiment, a user using a client computer 102 or a server computer 112 may use the budget purchase program 110a, 110b (respectively) to purchase services and/or products without actively browsing the internet, and to receive advice related to an optimal time to contribute funds to a desired item. The budget purchase method is explained in more detail below with respect to FIG. 2.

Referring now to FIG. 2, an operational flowchart illustrating the exemplary budget purchase process 200 used by the budget purchase program 110a and 110b according to at least one embodiment is depicted.

At 202, a wish list and a prioritization schedule are received. Once the budget purchase program 110a, 110b is installed on a user's device (e.g., a mobile device, a tablet, or a computer, among other connected devices), or once the budget purchase program 110a, 110b is accessed from a user's device (e.g., by logging in through a browser or launching a standalone program), the user may add services and/or products (i.e., collectively “items”) to a wish list. The budget purchase program 110a, 110b may also be referred to as an electronic payment application which may use a digital portal to enable a user to manage online assets (e.g., wish-listed items and/or monetary funds, among other things).

A user may add a prioritization schedule within the user's account, which may signify the order in which the user desires to purchase the wish-listed items. The prioritization value may be a numerical value (e.g., 1 through X, where X represents the total number of items on the user's wish list). The user may add a prioritization value to each item on the user's wish list, or may selectively choose to add a prioritization value to the top Y number of items on the user's wish list, where Y represents the number of items primarily desired by the user.

The user's wish list may represent items desired by the user which the user does not have sufficient funds to purchase.

The user's wish list may further contain a date by which the user desires to have the wish-listed item, and a maximum amount willing to spend for the item (e.g., a maximum amount that the user may afford to spend). The user's wish list may also, optionally, contain a list of preferred stores from which the user desires to purchase the wish-listed items.

At 204, funds are accepted (i.e., received). After adding items to a wish list within the budget purchase program 110a, 110b, the user may add funds to a piggybank, or may connect a bank account hosted on a separate website which may be accessed by the budget purchase program 110a, 110b. As was indicated above with respect to step 202, the user's wish list may represent items desired by the user which the user does not have sufficient funds to purchase. Accordingly, the user's piggybank may not contain sufficient funds to purchase all items on the user's wish list at the current price for which the items are being sold. The piggybank may, instead, represent a portion of the funds which may be required to purchase items on the user's wish list. The order in which items are purchased may be determined based on the user's wish list, prioritization schedule, and available funds, and will be described in more detail below with respect to steps 206 through 212.

Funds may be accepted (i.e., received) by the budget purchase program 110a, 110b as often as they are sent by the user. There may be no limit to the number of times, monthly or otherwise, that funds may be accepted (i.e., received) by the budget purchase program 110a, 110b. A user may, optionally, configure recurring or periodic fund deposits into the budget purchase program 110a, 110b piggybank, including but not limited to monthly, weekly, or daily deposits.

Once funds are accepted by the budget purchase program 110a, 110b, the budget purchase program 110a, 110b may calculate the percentage of funds needed to purchase all items on the user's wish list, which have been accrued by the user. The budget purchase program 110a, 110b may also calculate the percentage of the funds stored in the user's piggybank which may be used to purchase each item on the user's wish list. This may enable the user to accurately see how much of the user's savings may be used to purchase each individual item, and how much of the user's savings has been saved towards purchasing all items on the user's wish list.

At 206, an optimal purchase order (i.e., a purchase order) is determined. Once the user inputs a wish list and a prioritization schedule, and provides funds representative of the user's budget, the budget purchase program 110a, 110b may determine an optimal purchase order for the user's desired items. An optimal purchase order may be determined based on a series of queries by the budget purchase program 110a, 110b to determine one or more retailers (i.e., connected sources or purchasing sources) which sell the desired item. The budget purchase program 110a, 110b may also utilize a historical sale database (e.g., database 114) of seasonal and sale information, to analyze details of price fluctuations (i.e., analyzing a price trend) of items on the user's wish list, including but not limited to price trends.

The budget purchase program 110a, 110b may determine an optimal purchase order based on the method of buying all items on the user's wish list in the least amount of time, or the method of buying all items on the user's wish list which will require the least amount of money, among many other considerations, focuses, and/or intentions. The user may also, optionally, indicate certain items on the user's wish list which are to follow a particular purchase intention (e.g., purchase these items as soon as possible), and may indicate certain items on the user's wish list which are to follow a different purchase intention (e.g., purchase these items using the least amount of money as possible).

For example, the user may indicate within the budget purchase program 110a, 110b that the first three items on the user's prioritization schedule should be purchased as soon as possible and the remaining seven items on the user's prioritization schedule should be purchased as inexpensively as possible.

The budget purchase program 110a, 110b may also determine an optimal purchase order based on historical price data, sell out rate of an item, value of an item, seasonal sales, and the date by which the user wishes to have the desired item, among many other considerations.

A database (e.g., database 114) of historical sale information may be maintained and utilized by the budget purchase program 110a, 110b in determining an optimal purchase order. Maintenance of the database may include, but is not limited to including, uploading of promotion codes and timing of seasonal sales, and uploading of the purchase information (e.g., price and date) of sales executed by the budget purchase program 110a, 110b.

The budget purchase program 110a, 110b may also utilize news sources to keep track of new product releases, and may optionally maintain a separate database (e.g., database 114) of news information. Both past and present news information may assist the budget purchase program 110a, 110b in determining an optimal purchase order for a user's wish-listed items.

For example, if a new version of a desired item is scheduled to be released or has been announced, there might be an expectation that the price of an existing item (e.g., the wish-listed) may go down. In addition to news data, there may also may be historical sale data that may support this contention, which may be stored in the database of historical sale information, and may be analyzed by the budget purchase program 110a, 110b before an optimal purchase order is determined.

At 208, it is determined that the prioritization schedule does not match the optimal purchase order.

If, for example, an item on the user's wish list is rated 4 on the prioritization schedule, and an analysis of seasonal and sale information determines that the item will drop significantly in price for a one month period which is about to be reached, and the user's piggybank will have enough money to cover the rated 4 item while leaving an additional sum for another item, then the budget purchase program 110a, 110b may inform the user that the prioritization schedule does not match the optimal purchase order of the user's wish-listed items, and the budget purchase program 110a, 110b may request an updated prioritization schedule from the user.

At 210, an updated prioritization schedule is requested. The user may provide an updated prioritization schedule by logging in to the budget purchase program 110a, 110b from a connected mobile device or tablet, among many other connected devices, or by launching the budget purchase program 110a, 110b from a desktop application. A user may log in to the budget purchase program 110a, 110b to access a personalized profile (e.g., a user account). The user's profile may contain any defined preferences, the user's wish list, and the user's prioritization schedule, among other profile features. The user may edit, at any time, profile features contained within the user's profile. This may include editing the user's wish list and/or prioritization schedule of the user's desired items.

At 212, an updated prioritization schedule is received. Once a user updates the prioritization schedule within the user's profile of the budget purchase program 110a, 110b, and saves any changes made to the user's account, the saved changes may automatically be reflected, and the budget purchase program 110a, 110b may once again determine the optimal purchase order, as described previously at 206. Based on the updated profile information and optimal purchase order, the budget purchase program 110a, 110b may determine whether the prioritization schedule now matches the optimal purchase order, as described previously at 208.

If, at 208, it was determined that the prioritization schedule did match the optimal purchase order, then at 214, items (i.e., target items) from the user's wish list would have been purchased. Once there are enough funds in the user's piggybank of the budget purchase program 110a, 110b, the budget purchase program 110a, 110b may automatically purchase items at the lowest price found from a credible source. A user may optionally configure, within the user's profile, that certain stores are not deemed credible by the user and should not be used by the budget purchase program 110a, 110b. A user's consent to purchase an item at a given price may be provided within the user profile of the budget purchase program 110a, 110b.

For example, Julia has installed the budget purchase program 110a, 110b on her mobile device. Julia desires to save her money for a special watch, running sneakers, and concert tickets. Julia inputs her wish list items into the budget purchase program 110a, 110b, and includes the dates by which Julia desires to have the wish-listed items. Julia also includes a maximum purchase price, and a prioritization schedule indicating the order in which Julia wishes that the items be purchased. Julia gives the concert tickets a prioritization value of 1, the highest prioritization value that there is. Julia leaves the two remaining items unrated, as she intends on allowing the budget purchase program 110a, 110b to determine the most inexpensive means by which to purchase the two remaining items. Accordingly, the budget purchase program 110a, 110b may query all websites to determine the best value for the items on Julia's wish list, and may continue to query until all items are able to be purchased.

Julia sets up recurring weekly payments (e.g., deposits) to the budget purchase program 110a, 110b with the money that she receives from babysitting. This amounts to an average of $100 per week. As a result of Julia's prioritization schedule, the budget purchase program 110a, 110b allocates a large percentage of money deposited each week towards Julia's concert tickets, as the date that Julia wants to have the tickets by is quickly approaching.

After one month, the funds needed for the concert tickets are available within Julia's piggybank of the budget purchase program 110a, 110b, and the budget purchase program 110a, 110b is able to find two tickets within Julia's budget. Julia's tickets are purchased, leaving two items remaining on Julia's wish list.

Julia's earlier specification was to purchase the remaining items in a method which saves Julia the most amount of money. As a result, the budget purchase program 110a, 110b continues to receive money contributed by Julia, but does not execute a purchase for the remaining two items until additional factors, such as seasonal sales, are considered. The budget purchase program 110a, 110b determines that the holidays are approaching, and the price of Julia's desired watch will not likely be reduced until after the holidays are done. The shoes, however, can be purchased in advance of the holidays since there are several store promotions which Julia can take advantage of. Therefore, once the funds in Julia's piggybank are sufficient to purchase Julia's desired shoes, the budget purchase program 110a, 110b arranges for Julia's purchase of this item.

The above steps are repeated until all items on Julia's wish list have been purchased.

As a second example, Johnny is a twelve-year-old boy who receives $15 per week for doing his chores. Johnny's mom deposits the money that Johnny is owed into a piggybank in Johnny's budget purchase program 110a, 110b account. Johnny goes into the account and selects the three things he has been wanting from shops that Johnny regularly shops at. The budget purchase program 110a, 110b requests that Johnny provide a prioritization schedule for the wish-listed items. Johnny prioritizes a bike, and indicates that the budget purchase program 110a, 110b can determine the best way to purchase the remaining items, requesting that the budget purchase program 110a, 110b save Johnny the most amount of money. Given the budget and date restrictions provided by Johnny within the budget purchase program 110a, 110b, the budget purchase program 110a, 110b determines that 75% of Johnny's weekly earnings should be contributed towards the purchase of Johnny's bike, and that the remaining items can be purchased for a reasonable price within the next month, based on upcoming sales.

Once each item is ready to be purchased for Johnny, based on the above considerations, Johnny receives a notification and budget purchase program 110a, 110b confirms the purchase.

It may be appreciated that FIG. 2 provide only an illustration of one embodiment and do not imply any limitations with regard to how different embodiments may be implemented. Many modifications to the depicted embodiment(s) may be made based on design and implementation requirements.

FIG. 3 is a block diagram 900 of internal and external components of computers depicted in FIG. 1 in accordance with an illustrative embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 3. Each of the sets of internal components 902 a, b includes one or more processors 906, one or more computer-readable RAMs 908 and one or more computer-readable ROMs 910 on one or more buses 912, and one or more operating systems 914 and one or more computer-readable tangible storage devices 916. The one or more operating systems 914, the software program 108, and the budget purchase program 110a in client computer 102, and the budget purchase program 110b in network server 112, may be stored on one or more computer-readable tangible storage devices 916 for execution by one or more processors 906 via one or more RAMs 908 (which typically include cache memory). In the embodiment illustrated in FIG. 3, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the budget purchase program 110a and 110b can be stored on one or more of the respective portable computer-readable tangible storage devices 920, read via the respective R/W drive or interface 918 and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the budget purchase program 110a in client computer 102 and the budget purchase program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the budget purchase program 110a in client computer 102 and the budget purchase program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926 and computer mouse 928. The device drivers 930, R/W drive or interface 918 and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

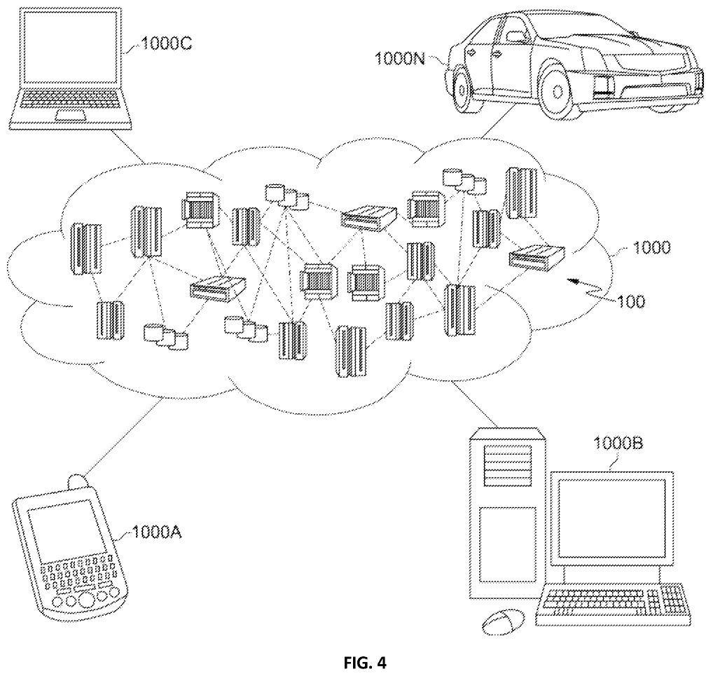

Referring now to FIG. 4, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 4 are intended to be illustrative only and that computing nodes 100 and cloud computing environment 1000 can communicate with any type of computerized device over any type of network and/or network addressable connection (e.g., using a web browser).

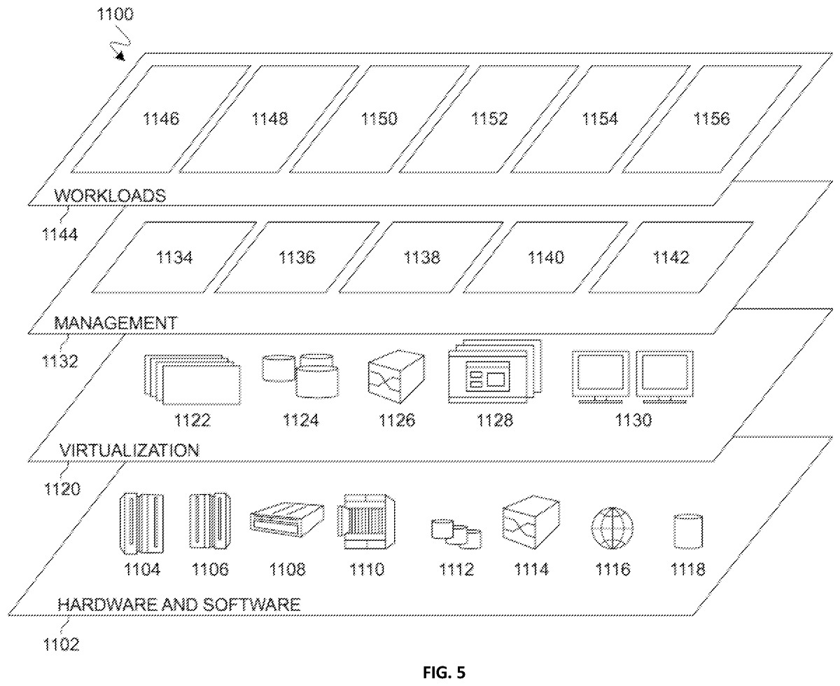

Referring now to FIG. 5, a set of functional abstraction layers 1100 provided by cloud computing environment 1000 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and budget purchase 1156. A budget purchase program 110a, 110b provides a way to permit a user to purchase services and/or products without actively browsing the internet, and may further advise a user as to an optimal time to contribute funds to a desired item.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for managing an electronic payment application, the method comprising:
managing online assets using a digital portal, whereby the digital portal determines a purchase order based on conditions of a wish list and a prioritization schedule being met, and releases funds to trigger the electronic purchase of a target item.

2. The method of claim 1, wherein the wish list further comprises:
one or more target items to be purchased.

3. The method of claim 1, wherein the prioritization schedule further comprises:
a numerical value corresponding to a desirability of an item.

4. The method of claim 1, wherein determining the purchase order further comprises:
querying one or more connected sources; and
analyzing a price trend.

5. The method of claim 1, further comprising:
determining that the prioritization schedule does not match the purchase order;
requesting an updated prioritization schedule; and
receiving an updated prioritization schedule, wherein managing online assets is performed in accordance with the updated prioritization schedule.

6. The method of claim 1, wherein the digital portal determines the purchase order based on an indication to limit time or to limit money.

7. The method of claim 1, wherein managing online assets comprises:
receiving funds by the digital portal.

8. A computer system for managing an electronic payment application, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
managing online assets using a digital portal, whereby the digital portal determines a purchase order based on conditions of a wish list and a prioritization schedule being met, and releases funds to trigger the electronic purchase of a target item.

9. The computer system of claim 8, wherein the wish list further comprises:
one or more target items to be purchased.

10. The computer system of claim 8, wherein the prioritization schedule further comprises:
a numerical value corresponding to a desirability of an item.

11. The computer system of claim 8, wherein determining the purchase order further comprises:
querying one or more connected sources; and
analyzing a price trend.

12. The computer system of claim 8, further comprising:
determining that the prioritization schedule does not match the purchase order;
requesting an updated prioritization schedule; and
receiving an updated prioritization schedule, wherein managing online assets is performed in accordance with the updated prioritization schedule.

13. The computer system of claim 8, wherein the digital portal determines the purchase order based on an indication to limit time or to limit money.

14. The computer system of claim 8, wherein managing online assets comprises:
receiving funds by the digital portal.

15. A computer program product for managing an electronic payment application, comprising:
one or more computer-readable storage media and program instructions stored on at least one of the one or more tangible storage media, the program instructions executable by a processor to cause the processor to perform a method comprising:
managing online assets using a digital portal, whereby the digital portal determines a purchase order based on conditions of a wish list and a prioritization schedule being met, and releases funds to trigger the electronic purchase of a target item.

16. The computer program product of claim 15, wherein the wish list further comprises:
one or more target items to be purchased.

17. The computer program product of claim 15, wherein the prioritization schedule further comprises:
a numerical value corresponding to a desirability of an item.

18. The computer program product of claim 15, wherein determining the purchase order further comprises:
querying one or more connected sources; and
analyzing a price trend.

19. The computer program product of claim 15, further comprising:
determining that the prioritization schedule does not match the purchase order;
requesting an updated prioritization schedule; and
receiving an updated prioritization schedule, wherein managing online assets is performed in accordance with the updated prioritization schedule.

20. The computer program product of claim 15, wherein the digital portal determines the purchase order based on an indication to limit time or to limit money.
